(19) United States
(12) Patent Application Publication
(10) Pub. No.: US 2013/0138584 A1
(43) Pub. Date: May 30, 2013

(54) METHOD FOR INCREASING SLOTS AT AN AIRPORT

(71) Applicants: Jan Vana, Ricany (CZ); Isaiah W. Cox, Baltimore, MD (US); Aaron Bianco, University City, MO (US); Rodney T. Cox, North Plains, OR (US)

(72) Inventors: Jan Vana, Ricany (CZ); Isaiah W. Cox, Baltimore, MD (US); Aaron Bianco, University City, MO (US); Rodney T. Cox, North Plains, OR (US)

(21) Appl. No.: 13/669,428

(22) Filed: Nov. 5, 2012

Related U.S. Application Data
(60) Provisional application No. 61/556,171, filed on Nov. 4, 2011.

(51) Int. Cl. G06Q 90/00

(52) U.S. Cl. CPC G06Q 90/00
USPC 705/500

(57) ABSTRACT

A method is provided for increasing the number of takeoff and landing slots and increasing gate capacity at airports with slot controls, including airports that are constrained from operation by curfews that limit the hours when aircraft can operate. The present method is intended to be used in connection with an aircraft that is equipped with onboard wheel drive means capable of translating torque through aircraft wheels and controllable to move the aircraft independently on the ground quietly and efficiently to a runway for takeoff without reliance on the aircraft's engines or the use of external tow vehicles.

### PRIORITY CLAIM

This application claims priority from U.S. Provisional Application No. 61/556,171, filed Nov. 4, 2011, the disclosure of which is fully incorporated herein.

### TECHNICAL FIELD

The present invention relates generally to calculating airport slots, the number of flights an airport can handle in a given time period, and, specifically, to a method for increasing an airline's slots at an airport.

### BACKGROUND OF THE INVENTION

In this era of increased air travel, many airports have reached their capacity to accommodate the numbers of aircraft seeking to use them. Delays in taking off and landing have increased as air traffic has increased to meet the demand for air travel. At some airports, the demand for runway and gate access exceeds the supply, which has resulted in the allocation of both takeoff and landing slots and gates. The number of flights an airport can handle in a given time period is fixed, and these resources are allocated to airlines to ensure that runway and gate access is maximized and delays are minimized. The allocation of takeoff and landing slots and gate access to airlines was instituted to control air traffic into and out of busy airports, in an effort to eliminate or at least control and reduce time delays, which had been described as excessive, quite costly, and to expand an airport's limited capacity. Some less busy airports have instituted takeoff slot and landing slot controls only during peak usage times.

There are currently over 150 airports around the world, almost 100 in Europe alone, where demand exceeds airport capacity, and, as a result, takeoff slots and landing slots are allocated to the airlines that routinely take off and land at these airports. In many of these airports, gates at terminals, which are generally rented from airport owners under long term leases, are also at a premium, and the leases are bought and sold among airlines. The United States currently has only three takeoff and landing slot-controlled airports and four others where takeoff slots are allocated during peak hours. Terminal gates are also at a premium in these airports. The numbers of available takeoff slots, landing slots, and gates are generally limited, and some airlines have takeoff slots, landing slots, and terminal gate rights that have been “grandfathered” for historical reasons. To schedule departures and/or arrivals out of takeoff or landing slot-controlled airports, airlines must acquire the necessary gates and takeoff and landing slots before they can use these airports. If the airport is one that does not have a shortage of gates or takeoff and landing slots, an airline can acquire the necessary slots fairly easily. If, however, the airport has no gates or takeoff or landing slots available, obtaining these required resources presents challenges for an airline.

Slot management systems have been proposed, as have methods and systems for allocating airport slots. U.S. Pat. No. 6,789,011 to Baiada et al and U.S. Patent Application Publication No. US2009/0089789 to Faltings et al, for example, describe such systems. Airlines are generally not in favor of such systems, and a need for a slot management system has been referred to as indicative of a failure to take the steps needed to keep up with air travel demand. Airlines have invested billions of dollars in aircraft and must have the degree of certainty provided by takeoff and landing slots and airport terminal gates, ensuring the airlines' access to airports in the future.

Airlines presently consider their gates and takeoff and landing slots airline property and would like to be free to use these slots as they desire. Such gates and takeoff and landing slots generally have a monetary value, and airlines sell and lease them as they would any other asset. Some economists and others view the current system as anti-competitive and urge that airlines with grandfathered gates and congested peak time takeoff and landing slots may have an unfair advantage, especially when airlines operate flights primarily to guard their slots and keep out competitors. This view has apparently not affected the market for slots. At some airports, London Heathrow, for example, gates and takeoff slots are in great demand and generally sell for at least £2 million to £3 million each. Very desirable gates and takeoff slots may command even higher prices. Gates and takeoff or landing slots tend to be transferred on a yearly basis, with the original putative owner retaining underlying ownership and the ability to resell these same gates and takeoff or landing slots.

New takeoff and landing slots, especially at busy airports, seldom become available, and both new airlines and established airlines that want to expand may have limited or no access to slots. If, under some arrangements, an airline does not use an allocated gate or a takeoff or landing slot 80% of the time, the airline risks losing them, and another airline could acquire the gate or the takeoff or landing slot, but this is not a reliable way to obtain a gate or a takeoff or landing slot. Since airlines swap and exchange gates and takeoff and landing slots among themselves, a gate or a takeoff or landing slot might be acquired in this manner. Takeoff and landing slots may also be acquired at auction. The International Air Transport Association (IATA) has suggested that when new takeoff and landing slots become available, they could be put into a slot pool, with a portion of the slots required to be made available to new entrant carriers that are currently operating with a small number of slots, for example, on the order of less than two pairs of slots per day. A single gate may be used in connection with many takeoff slots and/or landing slots, and an airline's acquisition of gates is not necessarily tied to the airline's acquisition of takeoff or landing slots. Takeoff and landing slots are limited to the number of runways at an airport and distances allowed between aircraft.

All of the foregoing suggestions, however, are based on an airline increasing its takeoff and landing slots or gates by the re-allocation of existing resources. The addition of new takeoff slots and landing slots and the more intensive use of gates presents other challenges. While these new takeoff and landing slots and increased gate use could be achieved by expanding airport capacity, few airports have that capability. Even when expansion is possible, it could be decades before the regulatory approvals and construction needed for the infrastructure expansion needed to increase takeoff and landing slots and add gates are obtained. Even if the necessary regulatory approvals could be obtained easily and quickly, which is rarely the case, the addition of new runways, new taxiways, and new terminal gates is very expensive.

Expanding the airport operating time could produce new takeoff and landing slots. Many of the world's major airports have curfews or use restrictions, however, which can drastically reduce airport capacity. Limitations and restrictions on airport operation can also reduce the value of additional airport infrastructure. Most airports currently do not operate at night or during other selected hours because of curfews. A curfew demands that all takeoffs and landings occur only within a specific time period and prohibits all takeoffs and landings outside this time period. The majority of airports in Europe, for example, are curfew-controlled, and this is not likely to change. The basis for most curfews is the noise produced by incoming and outgoing aircraft. The reduction of engine emissions is an additional reason for limiting airport operating hours. Aircraft noise becomes an issue when aircraft are required to use engine thrust for ground travel prior to take off and after landing. Even when a tug or tow vehicle is used to push the aircraft back from a gate, the aircraft's engines are still presently required for aircraft ground movement between pushback and takeoff, and this generates significant noise and other pollution.

Moving an aircraft on the ground without the use of a tug or tow vehicle or relying on thrust from the aircraft's engines has been proposed. U.S. Pat. No. 7,891,609 to Cox et al, owned in common with the present application, describes moving an aircraft along taxiways using at least one self propelled undercarriage wheel to improve turnaround time. The use of this system to increase the number of available takeoff and landing slots and increased gate usage at an airport is not suggested, however.

In U.S. Pat. No. 7,445,178, McCoskey et al describe a powered nose aircraft wheel system useful in a method of taxiing an aircraft in combination with a precision guidance system that can minimize the assistance needed from tugs and the aircraft engines. A method for actually increasing the number of takeoff and landing slots available and/or increased usage of gates at an airport using this system is not mentioned.

None of the foregoing art suggests increasing takeoff slots by moving an aircraft on the ground so that it can be on the runway ready for takeoff when an airport's curfew restrictions are lifted while the next departing aircraft can be loaded and ready for departure at the same gate from which the first aircraft departed.

The prior art, therefore, fails to suggest a method for increasing the number of takeoff and landing slots available at an airport or increasing gate availability and utilization without extending the airport hours of operation, reducing curfew hours, or adding airport infrastructure.

### SUMMARY OF THE INVENTION

It is a primary object of the present invention, therefore, to overcome the deficiencies of the prior art and to provide a method for increasing the number of takeoff and landing slots available and increasing gate availability and utilization at an airport without extending the airport hours of operation, reducing curfew hours, or adding airport infrastructure.

It is another object of the present invention to provide a method for increasing early morning slots available at an airport.

It is an additional object of the present invention to provide a method for increasing the number of takeoff slots available at airports with curfews.

It is a further object of the present invention to provide a method for increasing the number of landing slots available at airports with curfews.

It is a further object of the present invention to provide a method for increasing the efficient use of early morning slots available at an airport whereby aircraft are on the runway ready for takeoff when an airport's morning curfew expires.

It is yet another object of the present invention to provide a method for increasing the number of arrivals and departures at gates at an airport without increasing airport infrastructure capacity.

It is yet a further object of the present invention to provide a method for increasing takeoff and landing slots and gate usage at airports that are both slot-controlled and curfew-controlled.

It is yet an additional object of the present invention to provide a method for increasing airport facilities utilization and aircraft utilization without increasing costs incurred by an airport.

The aforementioned objects are achieved by providing a method for increasing the number of takeoff and landing slots and increasing gate usage at airports with slot controls, including airports that are constrained from operation at certain times by curfews that limit the hours when aircraft can operate. The present method is intended to be used in connection with an aircraft that is equipped with onboard wheel drive means capable of translating torque through aircraft wheels and controllable to move the aircraft on the ground independently without complete reliance on the aircraft's engines or the use of external tow vehicles. One or more controllable drive wheels, each of which may be powered by onboard electric, hydraulic, or other wheel drive means, is provided to move the aircraft quietly and efficiently to a runway for takeoff and to a gate or other airport arrival location after landing.

Other objects and advantages will be apparent from the following description, drawings, and claims.

### BRIEF DESCRIPTION OF THE DRAWING

FIG. 1 is a perspective view of an aircraft taxiing on a runway for takeoff in accordance with the method of the present invention.

### DESCRIPTION OF THE INVENTION

To keep airline schedules operating on time and to reduce delays at airports without the capability for expanding their physical infrastructure and accommodating additional aircraft takeoffs and landings, airports have determined the number of flights an aircraft could handle in a defined period of time and allocated these slots to airlines. Certain takeoff and landing slots at certain airports and at certain times have become very desirable to airlines, and those takeoff and landing slots are, as a result, very valuable. Competition for such slots can be intense, especially at a busy airport such as London's Heathrow, for example, where both takeoff and landing slots at the expiration of morning curfew are in great demand. As discussed above, adding new gates, terminal facilities, and runways to accommodate additional takeoff and landing slots to increase the total number of slots at an airport is difficult. This is especially problematic at airports where hours of operation are restricted by curfew, and the likelihood of adding more gates or otherwise increasing infrastructure is, at best, a remote possibility or, more likely, nonexistent.

An airport with a night curfew is prohibited from allowing aircraft to land or take off early in the morning and late at night. A night curfew might extend, for example, from 11:00 PM to 6:00 AM. Local noise laws may prevent the operation of an aircraft's engines, whether on the ground or in the air during this time period. Consequently, airlines cannot schedule any flights that taxi, land or take off at an airport during the curfew. Aircraft engines must be shut off during the curfew time period, which means that landing has to be completed, and the aircraft must be at a gate with its engines off by the start of curfew. Takeoff must also be completed before the start of curfew. Aircraft engines cannot be started before curfew is lifted and cannot, therefore, be used to move an aircraft to a runway for takeoff. In addition, aircraft landing cannot occur until after curfew has been lifted. The effect of these restrictions is to extend the curfew time period and reduce the available slots, as well as to limit the number of possible aircraft movements at an airport.

The method of the present invention overcomes these challenges and extends the time available for aircraft takeoff and landing, which effectively increases the number of slots available before the curfew period begins and before it ends. Early morning takeoff slots and late night landing slots are especially attractive to many airlines and, consequently, are very valuable. The numbers of both early morning slots and late evening slots can be increased significantly by the present method as described in the Example below. Once an airline obtains a gate and/or a takeoff or landing slot, that gate or slot is an asset that the airline can trade, sell, or lease. Not all airlines will be able to take advantage of these newly available slots, however. These slots will be available only to an airline with aircraft that can travel on the ground without relying on thrust from operation of the main engines and will be able to be at the runway and ready for takeoff immediately when the curfew period has ended. As noted above, an airline may be able to acquire these slots. The availability of aircraft that can land just before the curfew period begins and travel to a gate or other parking location without the aircraft engines will also enable an airport to add late time slots just before the curfew period starts.

In accordance with the method of the present invention, an aircraft must be equipped to be driven during ground travel by at least one powered aircraft drive wheel that is powered by a controllable driver or drive means. This powered drive wheel is uniquely positioned to maneuver an aircraft in a variety of circumstances on the ground without reliance on the aircraft's engines or external tow vehicles or tugs.

The terms “driver” and “drive means,” as used herein, refers to any onboard driver, whether or not located in a wheel, capable of moving an aircraft on the ground. Drivers preferred for use with the method of the present invention could be hydraulic, pneumatic, electric, or any other type of driver that can transfer force through an aircraft wheel. The terms “drive wheels” and “self-propelled drive wheels,” as used herein, refer to any aircraft wheels that are connected to and powered or driven by a controllable onboard driver or drive means as described below. An onboard driver for a powered drive wheel optimally exerts sufficient power to propel or move the aircraft at runway speeds, and its preferred small size enables the driver to fit within a nose wheel or main wheel landing gear space or in any other convenient onboard location inside or outside the wheel, without limitation. An aircraft with a powered self-propelled nose wheel or other aircraft drive wheel, such as a main wheel, will have one or more wheel drivers mounted in driving relationship with one or more of the aircraft wheels to move the wheels at a desired speed and torque.

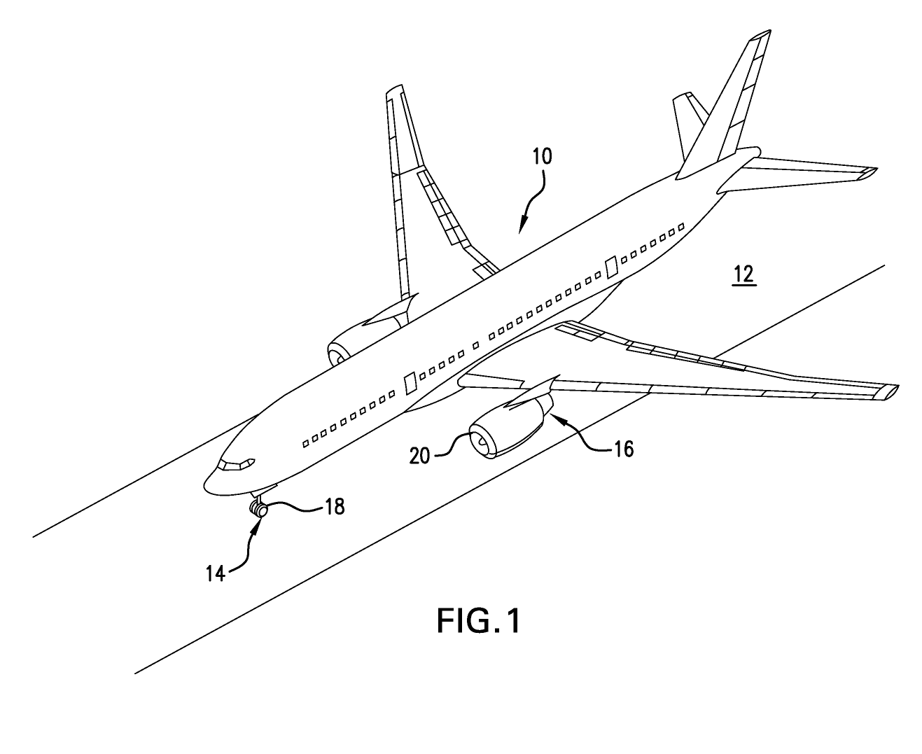

FIG. 1 illustrates an aircraft 10 taxiing on a runway 12 prior to takeoff. The nose landing gear wheels 14 and one set of the main landing gear wheels 16 of the aircraft 10 can be seen. One or more onboard drivers, designated 18 near the nose wheels 14, may be provided to power and drive either or both of the nose wheels, making them drive wheels capable of moving the aircraft on the ground without relying on thrust from the engines 20, one of which is visible. One or more onboard drivers 18 could, alternatively, be mounted in driving relationship with one or more of the main wheels so that one or more of the main wheels 16 become powered drive wheels.

In accordance with the present method for increasing airport slots, the aircraft's engines 20 can be turned off very shortly after landing and can remain off until very shortly before takeoff, which significantly reduces noise and engine emissions. Substantially eliminating reliance on the use of the aircraft engines during taxi also reduces aircraft fuel consumption and eliminates the jet blast, engine ingestion, noise, and air pollution associated with operation of an aircraft's engines on the ground. Even if an aircraft engine is required to provide electric power in an emergency situation, as discussed below, the engine can be set to provide no thrust. Tugs and external tow vehicles are also not required to move aircraft, so these vehicles and their operators are not needed. Aircraft taxi time is shortened when the time required to attach and detach a tug is eliminated. Consequently, not only is a safer, quieter, and less congested runway and ramp environment is possible, but an aircraft can proceed very quietly to a runway for takeoff and be ready for immediate takeoff when the curfew period is over in the early morning. An aircraft can also land at night and travel to a gate without significant noise or engine emissions.

Ground movement of the aircraft is produced by the operation of one or more controllable onboard drivers or drive means associated with one or more of the aircraft wheels, ideally powered independently of the aircraft's engines to cause one or more of the aircraft's wheels to rotate at a desired speed, or at a torque associated with a desired speed, thus providing the requisite power to move the aircraft at the desired speed. While, as indicated, a preferred location for a driver is adjacent to or within an aircraft wheel, driver locations are not limited. A driver can be positioned at any location where it can be connected with one or more aircraft wheels to provide the driving power required to move the aircraft wheel or wheels at a desired speed or torque and, hence, the aircraft at a desired speed on the ground. Possible locations for one or more drivers in addition to those within or adjacent to a wheel include, without limitation, on or near the wheel axle, in, on or near a landing gear bay or landing gear component, or any convenient onboard location in, on, or attached to the aircraft.

The aircraft's auxiliary power unit (APU) is the preferred source of electric power for powering drivers that require electric power and will provide the quietest ground movement of the aircraft when the aircraft moves during or close to the curfew time. In the event, however, that the aircraft's APU is inoperative or otherwise unavailable for supplying electric power, one or more of the aircraft's main engines' auxiliary power unit can be used as a back-up power source. While this may not ensure the same quiet ground travel operation as the aircraft's APU, operating only the engine auxiliary power unit is much quieter than operating an engine for thrust on the ground. Using the engine auxiliary power unit for power is not preferred for early morning or late evening aircraft ground travel.

One or more of an aircraft's main engines could additionally be employed as a source of bleed air for a drive wheel with a pneumatic driver. While the aircraft engines do not supply power nearly as efficiently as the APU, they do provide an available alternative in an emergency. Should it be necessary to rely on one or more engines to supply power or bleed air, the thrust levels can be set so that the engine or engines are providing only electric or pneumatic power to power the drive wheel to move the aircraft and are not providing thrust. Such engine use may be justified, in the event of an APU failure for example, to obtain at least some of the benefits of powered self-propelled aircraft ground movement.

One particularly preferred driver for use in connection with the present method is an electric driver that is preferably an enclosed machine capable of operating for at least several minutes at maximum torque and for over 20 minutes at cruise torque. This electric driver could be any one of a number of designs, for example an inside-out motor attached to a wheel hub in which the rotor can be internal to or external to the stator, such as that shown and described in U.S. Patent Application Publication No. 2006/0273686, the disclosure of which is incorporated herein by reference. A toroidally-wound motor, an axial flux motor, a permanent magnet brushless motor, a synchronous motor, an asynchronous motor, a pancake motor, a switched reluctance motor, electric induction motor, or any other electric motor geometry or type known in the art is also contemplated to be suitable for use in the present invention.

The driver or drive means selected, whether electric, hydraulic, pneumatic, or any other type of driver, should be able to move an aircraft wheel at a desired speed and torque during ground travel. One kind of electric drive motor preferred for this purpose is a high phase order electric motor of the kind described in, for example, U.S. Pat. Nos. 6,657,334; 6,838,791; 7,116,019; and 7,469,858, all of which are owned in common with the present invention. A geared motor, such as that shown and described in U.S. Pat. No. 7,469,858, is designed to produce the torque required to move a commercial sized aircraft at an optimum speed for ground movement. The disclosures of the aforementioned patents are incorporated herein by reference. As indicated above, any form of drive means or motor capable of driving a landing gear wheel to move an aircraft on the ground may also be used. Other motor designs capable of high torque operation across the desired speed range that can move an aircraft wheel to function as described herein may also be suitable for use in the present invention. A particularly preferred driver motor, which is useful in driving the 737 and/or the A320 family of aircraft, is a high phase order induction motor with a top tangential speed of about 15,000 linear feet per minute and a maximum rotor speed of about 7200 rpm. With an effective wheel diameter of about 27 inches and an appropriate gear ratio, an optimum top speed of about 28 miles per hour (mph) can be achieved, although any speed appropriate for aircraft ground travel suitable in an aircraft to produce the quiet ground movement that will increase airport slots according to the present invention could be used.

A wheel driver or drive means controllable to move an aircraft on the ground and enable the airline to qualify for increased slots in accordance with the present invention is specifically designed to be retrofitted on existing aircraft without requiring changes to existing wheel structures, including the brakes, to produce self-propelled drive wheels. A major advantage of the design of this wheel driver is achieved by the continued use of the existing tires, axle, and piston already in use on an aircraft. Since these structures are not altered from their original condition or otherwise changed in any way by the installation of the present wheel driver assembly, the rim width, tire bead, and bead seat would not require re-certification by the FAA or other authorities, thus eliminating a potentially time consuming and costly process. As a result, the wheel driver described herein is especially well suited for installation on existing aircraft to make these aircraft especially eligible for slots near the beginning or end of curfew. Additionally, the controls required to operate a wheel driver as described herein can be also retrofitted within the existing cockpit controls.

Moving an aircraft on the ground using a wheel driver as described above requires providing sufficient power to the driver to produce a torque capable of driving an aircraft wheel to move the aircraft at a desired ground speed. When an electric driver or drive means is used in the present method, the current, and the voltage and frequency of the current, applied to the motor can be controlled to regulate speed. In an aircraft wheel drive assembly useful in the present invention, current to power the motor most preferably originates with the aircraft auxiliary power unit (APU), as discussed above. Power sources, other than the aircraft engines, could also be used to supplement or replace the APU as a source of power. These power source can include, for example without limitation, batteries, fuel cells, any kind of solar power, POWER CHIPS®, and burn boxes, as well as any other suitable power source for this purpose. Control of the flow of current to the driver, as well as control of the voltage and frequency of the current, allows the torque generated by the driver to be controlled and, therefore, speed of the wheel powered by the driver and the ground travel speed of the aircraft can also be controlled.

An aircraft equipped with one or more onboard wheel drives as described above is capable of effectively generating additional slots by allowing earlier actual takeoffs and landings and increasing the number of takeoffs and landings possible compared to the number of takeoffs and landings possible at present. The Example below demonstrates this.

### EXAMPLE

### Airport With Curfew that Expires at 6:00 AM

### Current Practice

All aircraft required to be at gates until 6:00 AM. At 6:00 AM, aircraft can be pushed back and leave gates and engines can be turned on. Aircraft line up on runway for takeoff. The earliest flight cannot be scheduled to depart until 6:15 AM or later. All aircraft scheduled for the earliest slot must compete for available pushback tugs and ground crew. The earliest landing times available when curfew expires are among the most desirable, particularly at international airports, and aircraft landing at that time may have a long wait for gates, which are filled with aircraft waiting to turn on their engines and depart. Arriving aircraft may be stacked in the air waiting for landing approval and on the ground waiting for gates, while departing aircraft are waiting for towing equipment and then what can be a mad dash for the runways and takeoff.

### With the Method of the Present Invention

Aircraft equipped with onboard wheel drives that control aircraft ground movement do not require engines or tugs and can taxi quietly to a takeoff runway prior to the expiration of 6:00 AM curfew, line up in position for takeoff, and be ready to start engines at 6:00 AM for a 6:05 AM departure.

Assuming 2 minutes per takeoff, 5 more onboard wheel drive-equipped aircraft can take off before the 6:15 AM earliest departure now possible, creating 5 additional slots per runway. Two runways used in this manner would produce 10 additional slots. At a busy airport like Heathrow where early morning takeoff slots sell for £2 million or more, the value of the first ten aircraft equipped with onboard wheel drivers as described herein to fly out of Heathrow would be in the range of about $3 million to $5 million.

At an airport with a 30 minute taxi time from the gate to a runway takeoff location, an aircraft equipped with an onboard wheel drive can leave the gate quietly at 5:30 AM and be ready on the runway to start engines at 6:00 AM for a 6:05 AM takeoff. This frees gate space to load the next departing flight while the aircraft with the 6:05 AM slot is on the runway. Assuming 2 minutes per takeoff and 3 runways, 30 additional takeoff events are created without adding more gates. The addition of these 30 slots effectively adds 3 to 5 more gates to the airport. At

Heathrow, for example, each gate may have a worth that approaches about £3 million per year. This value may be significantly increased for landing aircraft.

Aircraft arriving as the curfew is lifted, whether equipped with an onboard wheel drive or not, will be able to proceed directly to assigned gates upon landing since these gates have been vacated by the earlier departing aircraft, as described above, and are available for the arriving aircraft. Significant time and expense savings should result from this efficient movement of aircraft.

With the method of the present invention, the evening curfew starting time could be set to start later, once airports realize that aircraft engine noise between landing and the gate will be, at most, minimal. The substantial elimination of noise pollution achieved by the present method makes it possible to extend the commencement of the evening curfew, giving airports an estimated 30 minutes additional use of its facilities at the end of the day without any expansion of the airport's infrastructure. A later curfew generates increased evening landing slots and increases gate capacity. Gate throughput is also increased, which decreases operating costs for airports and airlines.

Aircraft equipped with onboard wheel drives in accordance with the present invention, therefore, can enable airlines to schedule earlier and later arrival and departure flight times than is currently possible. This allows an airport to expand the number of possible takeoffs and landings in a set time period, effectively expanding an airport's available capacity without requiring expansion of the airport's actual infrastructure.

While the present invention has been described with respect to preferred embodiments, this is not intended to be limiting, and other arrangements and structures that perform the required functions are contemplated to be within the scope of the present invention.

### INDUSTRIAL APPLICABILITY

The method of increasing airport slots of the present invention will find its primary applicability in adding additional takeoff and landing slots to airports and expanding the opportunities for airlines and airports to increase gate utilization and, therefore, scheduling capacity, particularly at airports that are slot-controlled and curfew-controlled, while significantly decreasing per passenger airport infrastructure and per passenger operating costs.

1. A method comprising increasing the number of aircraft movements available at an airport without extending airport hours of operation or adding airport infrastructure, wherein one or more aircraft using said airport are equipped with onboard wheel drive means capable of translating torque through aircraft wheels to move said aircraft, and said onboard wheel drive means is controlled to move the aircraft quietly and efficiently on the ground at said airport between landing and takeoff without reliance on aircraft main engines or external tow vehicles, thereby decreasing aircraft time on the ground between landing and takeoff.

2. The method of claim 1, wherein said aircraft movements comprise departures and arrivals at an airport.

3. The method of claim 2, wherein the aircraft is moved on the ground by onboard wheel drive means comprising any motor capable of producing the torque required to move a commercial sized aircraft at an optimum speed for ground movement.

4. The method of claim 3, wherein the onboard wheel drive means is selected from the group consisting of electric induction motors, permanent magnet brushless DC motors, switched reluctance motors, hydraulic pump/motor assemblies, and pneumatic motors.

5. The method of claim 1, wherein the onboard wheel drive means is mounted on at least one aircraft nose wheel or on at least one aircraft main wheel.

6. The method of claim 1, wherein said onboard wheel drive means is powered by a power source selected from the group comprising an aircraft's auxiliary power unit, batteries, fuel cells, solar power, POWER CHIPS®, and burn boxes.

7. The method described in claim 3, wherein said onboard wheel drive means is an electric motor capable of driving an aircraft on the ground selected from the group comprising high phase order electric motors, electric induction motors, permanent magnet brushless DC motors, and switched reluctance motors.

8. The method described in claim 1, wherein said onboard wheel drive means is located at a selected location inside an aircraft nose or main wheel, at a selected location adjacent to an aircraft nose or main wheel, at a selected location within the aircraft, or at a selected location attached to the aircraft airframe.

9. A method comprising increasing takeoff and landing slots and increasing gate capacity at an airport where landings and takeoffs are restricted during a curfew period when aircraft engines are prohibited from operation, wherein aircraft are equipped with onboard wheel drive means capable of translating torque through aircraft wheels and controllable to move said aircraft quietly on the ground without operation of said aircraft's main engines, and are enabled to take off substantially immediately at an expiration of a curfew period or substantially immediately prior to a start of a curfew period.

10. The method of claim 9, further comprising using said onboard wheel drive means to drive said aircraft on the ground from a parking location to a takeoff runway prior to expiration of the curfew period, activating said aircraft's main engines, and causing the aircraft to take off substantially immediately at the expiration of said curfew period.

11. The method of claim 9, further comprising, upon landing of said aircraft substantially immediately prior to start of the curfew period, deactivating said aircraft's engines, and using said onboard wheel drive means to drive said aircraft from a location where said engines were deactivated to an arrival location.

12. The method of claim 9, wherein the aircraft is moved on the ground by onboard wheel drive means comprising any motor capable of producing the torque required to move a commercial sized aircraft at an optimum speed for ground movement.

13. The method of claim 12, wherein the onboard wheel drive means is selected from the group consisting of electric induction motors, permanent magnet brushless DC motors, switched reluctance motors, hydraulic pump/motor assemblies, and pneumatic motors.

14. The method of claim 9, wherein the onboard wheel drive means is mounted on at least one aircraft nose wheel or on at least one aircraft main wheel and is located at a selected location inside an aircraft nose or main wheel, at a selected location adjacent to an aircraft nose or main wheel, at a selected location within the aircraft, or at a selected location attached to the aircraft airframe.

15. The method of claim 9, wherein said onboard wheel drive means is powered by a power source selected from the group comprising an aircraft's auxiliary power unit, batteries, fuel cells, solar power, POWER CHIPS®, and burn boxes.

16. The method described in claim 12, wherein said onboard wheel drive means is an electric motor capable of driving an aircraft on the ground selected from the group comprising high phase order electric motors, electric induction motors, permanent magnet brushless DC motors, and switched reluctance motors.

17. A method comprising increasing the number of takeoff slots at an airport and effectively expanding airport infrastructure and gate capacity, wherein a plurality of aircraft using the airport are equipped with onboard wheel drive means capable of translating torque through aircraft wheels and controllable to move the aircraft on the ground quietly and efficiently; using said onboard wheel drive means to drive one of said plurality of aircraft from a gate at said airport to a runway for takeoff; and while said one aircraft is being driven to said runway, loading another of said plurality of aircraft at said gate for departure.

18. The method of claim 17, wherein said method is performed at substantially all gates at said airport where one of said plurality of aircraft is departing from a gate and another of said plurality of aircraft is arriving at said gate.
